(19) United States
(12) Patent Application Publication
(10) Pub. No.: US 2004/0201301 A1
(43) Pub. Date: Oct. 14, 2004

(54) Simple rotor assembly for a reluctance machine

(76) Inventors: Christopher Daniel Regan, Orono, MN (US); Wayne Peter Manders, Forest Lake, MN (US)

Correspondence Address: Christopher Regan, 3410 North Shore Drive, Wayzata, MN, 55413, US

(21) Appl. No.: 10/411,815

(22) Filed: Apr. 11, 2003

(51) Int. Cl. H02K 21/12; H02K 1/22

(52) U.S. Cl. 310/156.53

(57) ABSTRACT

A rotor assembly for a reluctance machine consisting of end holders with recesses for securing magnetic layers. The spaces between magnetic layers forming fillable nonmagnetic layers. These nonmagnetic layers being optionally not filled, filled with nonstructural material, filled with structural material, or a combination of these. If the nonmagnetic layers are filled with permanent magnets or a structural permanent magnet, consisting of honeycomb with embedded permanent magnets, the rotor then forms a hybrid permanent magnet machine. Spider holders and fiber wrapping optionally added to reinforce the rotor. This rotor assembly is also reversible so that the end holders' recesses secure the nonmagnetic layers instead of the magnetic layers. An assembly method for any configuration of the rotor assembly is set forth that employs simple manufacturing processes.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### TECHNICAL FIELD

The present invention relates generally to reluctance machines or hybrid permanent magnet and reluctance machines. More particularly, the present invention relates to the structure and construction of rotors for a reluctance or hybrid permanent magnet machine.

### BACKGROUND OF THE INVENTION

The present invention is understood to be able to act as either a motor or generator. To simplify, the invention will be referred to as a machine. A reluctance machine is typically either of the synchronous reluctance, doubly fed reluctance, or the switched reluctance type. The invented rotor is applicable to any reluctance type machine. In the synchronous reluctance type the machine is made up of a stator with poly-phase distributed windings forming a plurality of poles which are similar to those of induction machines, and a rotor. This rotor should also have the same number of poles as the stator. The doubly fed reluctance machine is very similar to the synchronous reluctance except the stator has two sets of windings on the stator. In this machine the rotor will have a number of poles determined by the number of poles of each winding. In the switched reluctance machine the stator is different in that it has concentric salient pole windings and the rotor can remain the same. In this machine the rotor and stator will have different numbers of poles. One common combination is six stator poles and four rotor poles. Since the differences in these machines occur only in the stator, the rotor configurations can be applied to any of the machines mentioned. By providing rotating fields in any of the stators' windings, a magnetomotive force acts upon the rotor resulting in the rotor being driven by the rotating field in the stator.

The synchronous reluctance machine rotor generally includes multiple layers of alternating magnetic layers and nonmagnetic layers spanning the length of the machine. For the two pole machine, these layers are flat sheets machined to be circular in cross section and secured with adhesive and or cup like end caps. In addition, mechanical fasteners such as bolts are often used to fasten the layers together. In the two pole machine, the shaft is usually formed from magnetic and nonmagnetic layers or is an integral part of the end caps. For numerous pole machines, the alternating layers are curved and secured to a spider. The spider acts as a holder which receives the shaft of the machine. These layers and spider holder are secured together using either cup like end caps or adhesive, and often utilize mechanical bolts inserted through the pole layers. For increasing constant power speed range, efficiency, inverter utilization, or other similar performance characteristics, permanent magnets may be added to the reluctance machine. These permanent magnets are normally placed in regions that would otherwise comprise nonmagnetic layers. This type of machine will be referred to as a hybrid permanent magnet machine.

Two other types of machine configurations include the use of stacked laminations filled with epoxy and secured with cup like end caps, as in U.S. Pat. No. 5,893,205, or stacked laminations that have bridges between magnetic layers to hold them together. Other configurations, such as U.S. Pat. No. 6,064,134 and U.S. Pat. No. 5,929,551, do not require either end caps or mechanical fasteners to secure the poles but, otherwise, are very similar to the first mentioned configuration.

The first configuration described has the disadvantage of using a layer of nonmagnetic material between the magnetic layers. These nonmagnetic layers do not contribute to producing magnetic torque, and therefore add extra weight, material cost, and assembly cost. The end caps in most machines also present a problem in that they add extra length to the rotor creating a longer total machine package. In addition, due to the magnetic sheets extending past the useful portion of the stator undesirable field effects can occur between the stator end turns and this extra rotor length. Also, unless constructed of an adequately stiff material, the end caps do not add significantly to the structural strength of the rotor. As a result they either add significant weight or do not allow the machine to incur high stresses, thus only allowing relatively slow rotation rates. In most machines bolts are also used to hold the assembly together. These bolts add to the weight, the cost of materials, the cost to manufacture, and also cause a high reluctance path in the magnetic circuit wherever they are located. In the case of the hybrid permanent magnet machine, except for the two pole machine, it becomes extremely difficult to incorporate permanent magnets into the structure and also to magnetize them or have them retain their magnetic field during the manufacturing process. This is due to elevated temperatures often involved in many manufacturing processes and the lack of a simple method of magnetizing the permanent magnets after they are assembled in the rotor.

The stacked laminations with epoxy method, U.S. Pat. No. 5,893,205, while providing a machine that is comprised of inexpensive material and light weight, suffers from a generally low structural strength. In addition the assembly of the rotor involves a complicated process. It is also not possible to incorporate a hybrid permanent magnet machine due to the nonmagnetic layers having to consist of epoxy.

For stacked laminations having bridges between the magnetic layers, the rotor has no material for the nonmagnetic layers. The first problem with this design is that it is not mechanically strong due to the weak bridge connections holding magnetic layers together. Another problem with this configuration is that for a given rotor radius and given rotor to stator gap, the efficiency, inverter utilization, and maximum torque of the machine are decreased significantly.

The methods, listed in U.S. Pat. No. 6,064,134, decrease the weight of the insulation in some instances, but they do so by using dimples, which significantly increase the cost of material and cost of manufacturing. The U.S. Pat. No. 6,064,134 has a problem similar to that of the first configuration in that the length of the rotor must be extended to allow the attachment of circumferential bands that function similar to end caps. U.S. Pat. No. 5,929,551 avoids the use of end caps and extra length but has a similar problem with mechanical fasteners being inserted through the pole layers. The difference is that the bolts have been replaced by an elaborate spider holder with integrated fasteners. This pole holder increases the cost of the rotor and also causes a high reluctance path in the magnetic circuit wherever the pole holder mounts are located.

This invention overcomes many of the limitations found in the prior art described previously. One of the advantages of this invention is that no material is required for the nonmagnetic layers. This reduces the cost of materials, the cost of assembly, and the rotor weight. The end holders of the invention can also be made such that magnetic material does not extend past the magnetic portion of the stator. In addition, the nonmagnetic end holders may be made to not extend beyond the winding end turns of the stator. This results in a shorter total machine package length, reduced weight for a given structural strength, and no difficulties with interactions between winding end turns and rotor. It is a simple matter to incorporate the hybrid permanent magnet machine with this invention. The permanent magnets can be magnetized and formed outside the rotor assembly and later secured in the assembled rotor. With this design the overall manufacturing is greatly reduced in cost and complexity.

Support sections can easily be added to mechanically reinforce the magnetic layers of the rotor. These structural reinforcements can be added to the rotor without significantly increasing the cost and weight of the machine.

For high stress applications, honeycomb may be secured in the nonmagnetic layers. This provides a very strong structure suitable for applications requiring high rotation rates while maintaining low structural weight and minimally increasing total cost. A new type of structural permanent magnet is also introduced to allow for a hybrid permanent magnet machine at these stresses. This new permanent magnet structure consists of combining the honeycomb with permanent magnets prior to rotor assembly. This is possible because the permanent magnets can occupy the cells of the honeycomb and be magnetized externally and later secured in the otherwise assembled rotor.

To further reduce the stresses within the rotor, it can be circumferentially wrapped with fiber. Fiber wrapping can be used as the sole reinforcement method or in conjunction with either of the preceding reinforcement methods to result in a rotor that can withstand rotation rates that could otherwise not be achieved.

In any of the rotor variations mentioned the most important feature may be that production cost is minimal and increases only with the necessity of improved performance. Further features and advantages of the invention will become apparent from a consideration of the drawings and ensuing description.

### SUMMARY OF THE INVENTION

The rotor of this invention consists of magnetic layers spanning the length of the rotor which are either flat or curved. These layers are constrained by end holders. The end holders hold the magnetic layers in place with recesses located in the end holders. Except for the end holder regions, the nonmagnetic layers are a space that may be left empty or filled with any kind of matter. Thus, this nonmagnetic layer does not have to be structural due to the structure of the magnet layers and end holders. Advantages are thus gained of lower weight, decreased material cost, and decreased assembly cost. These are attained while not compromising the mechanical structure.

Permanent magnets may also be secured in the nonmagnetic layers for a hybrid permanent magnet machine. This rotor allows for a convenient method of incorporating permanent magnets in the rotor assembly.

For some applications of the invention it may be necessary for the rotor to withstand large forces. These forces are generally due to electromagnetic forces between the rotor and stator and centrifugal forces due to the rotation of the rotor. To increase the ability of the rotor to withstand elevated forces, the rotor can be reinforced with cross-sectional supports, spider holders, honeycomb sheets, a new structural permanent magnet, fiber wrapping, or any combination of these reinforcements. This allows for the weight and cost of the rotor to be increased only when necessitated by high forces on the rotor. In addition the increases in weight and costs are minimal for the amount of mechanical strength added.

The rotor of this invention is also reversible so that the end holders' recesses secure the nonmagnetic layers instead of the magnetic layers. In this configuration the magnetic layer can be a nonstructural material. While most of the configurations can generate induction torque by making the nonmagnetic layers conductive, this configuration provides a more convenient method of accomplishing this.

An assembly method for any configuration of the rotor assembly employs simple manufacturing processes. The basic manufacturing steps consist of fabricating the rotor components, securing the components together, and performing finishing steps.

### BRIEF DESCRIPTION OF THE DRAWINGS

### Figures

The present invention will be described with reference to the accompanying drawings in which:

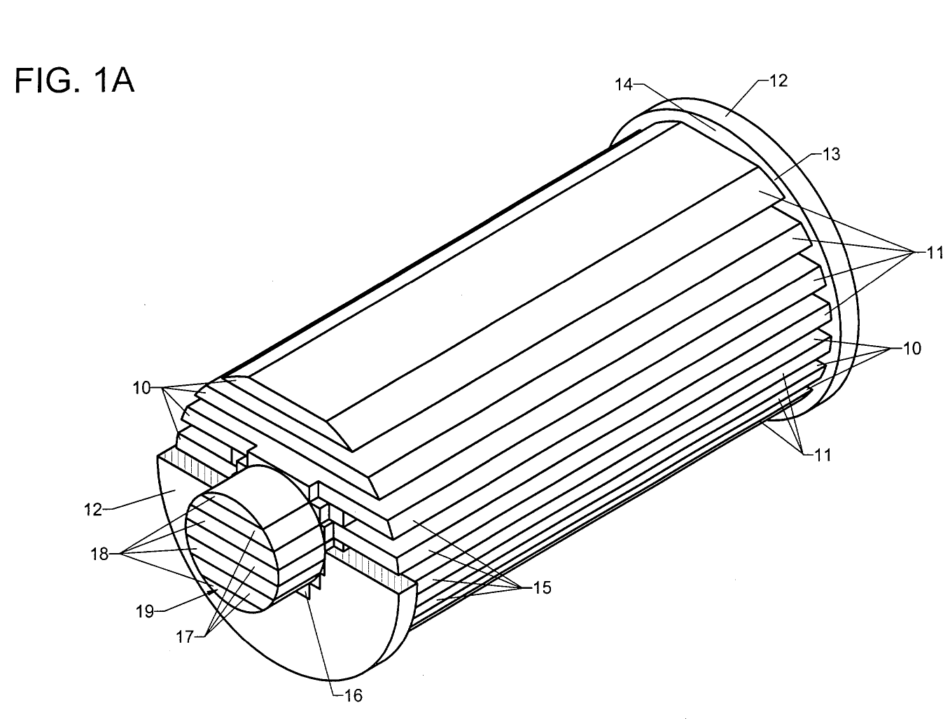

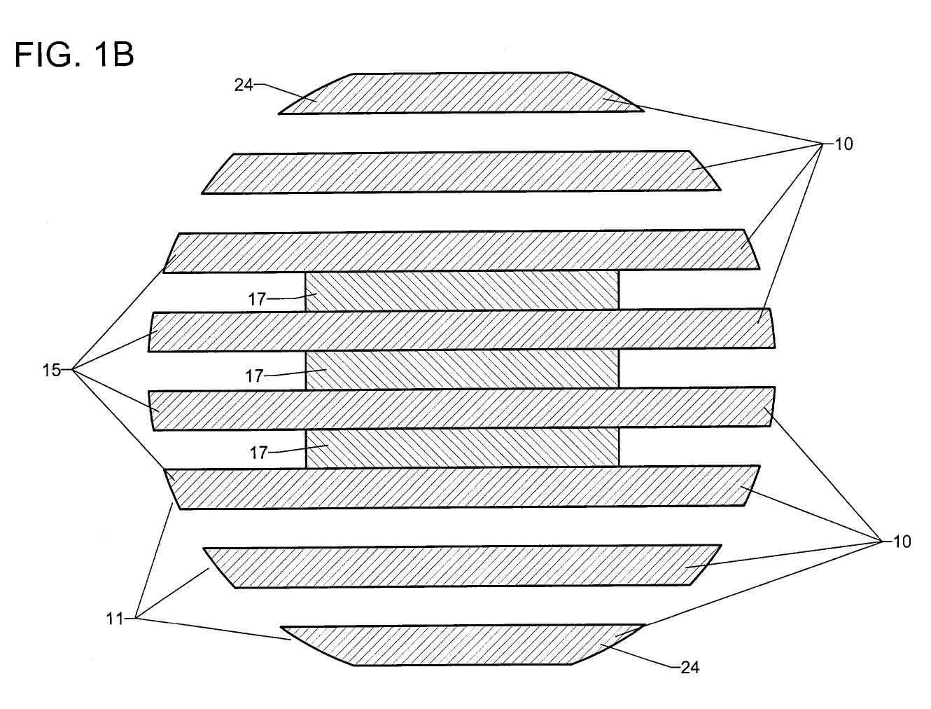

FIG. 1A is a perspective view of a two pole rotor with the nearest end holder partially in section;

FIG. 1B is a sectional view of the two pole rotor depicted in FIG. 1A; the section depicted is between and parallel to the end holders;

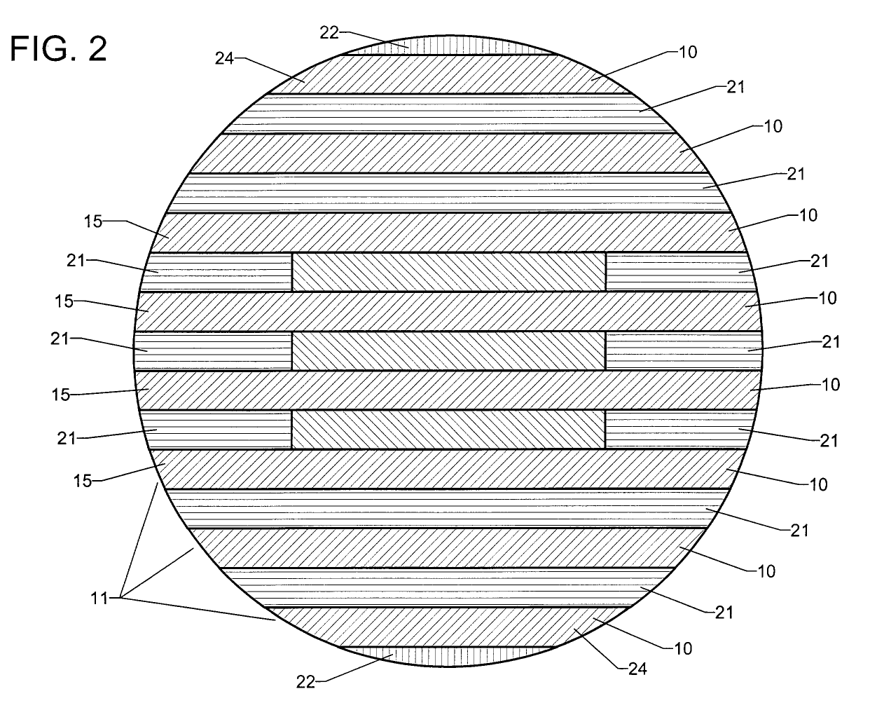

FIG. 2 is a sectional view of a two pole rotor with filled nonmagnetic layers; the section depicted is between and parallel to the end holders;

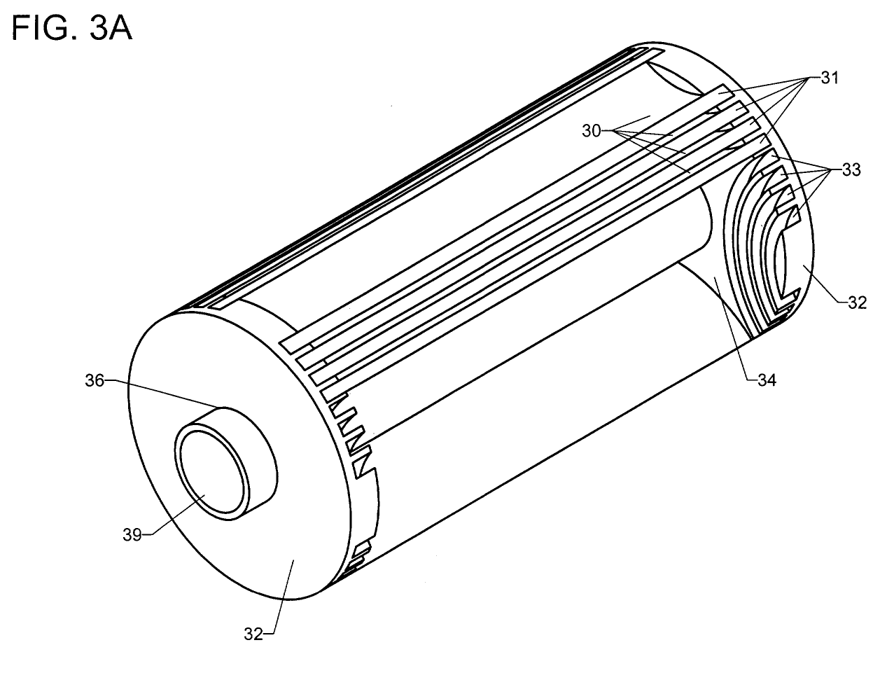

FIG. 3A is a perspective view of a partially assembled four pole rotor;

FIG. 3B is a sectional view of the four pole rotor depicted in FIG. 3A; the section depicted is between and parallel to the end holders;

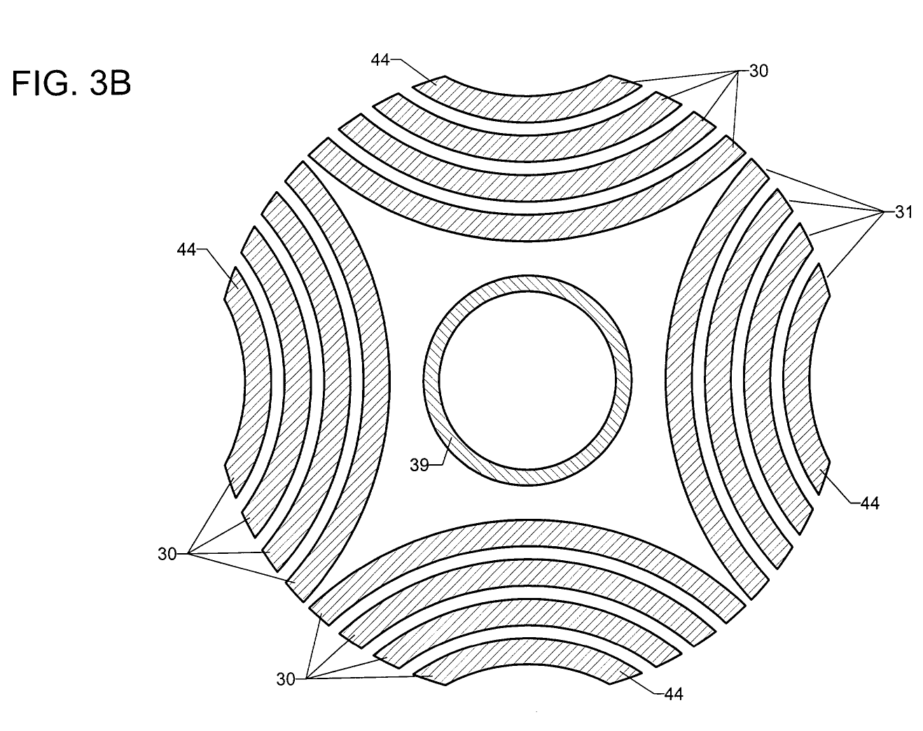

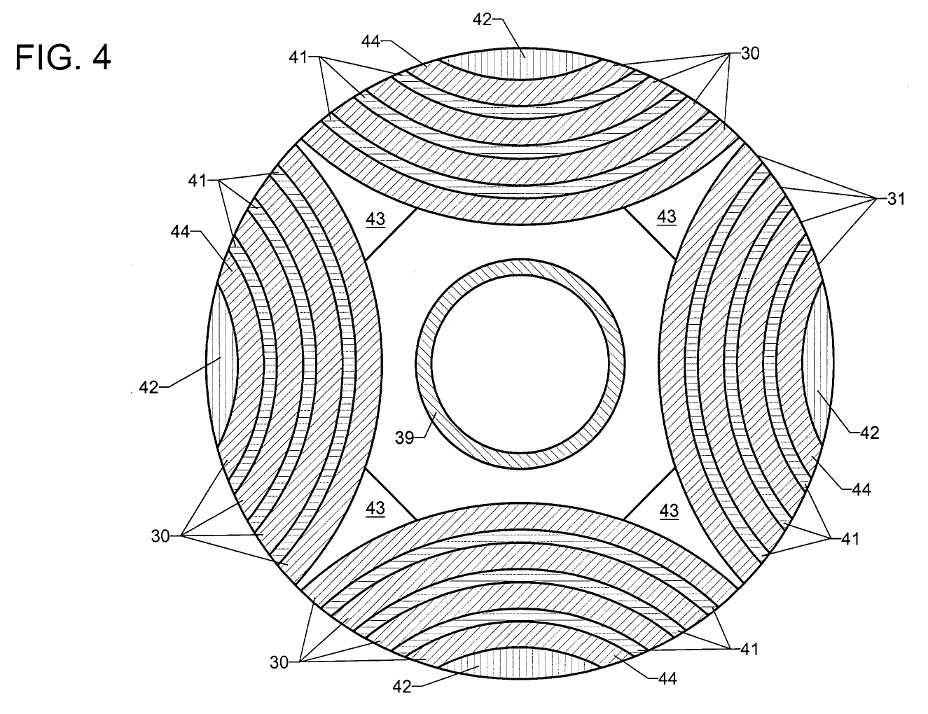

FIG. 4 is a sectional view of a four pole rotor with filled nonmagnetic layers; the section depicted is between and parallel to the end holders;

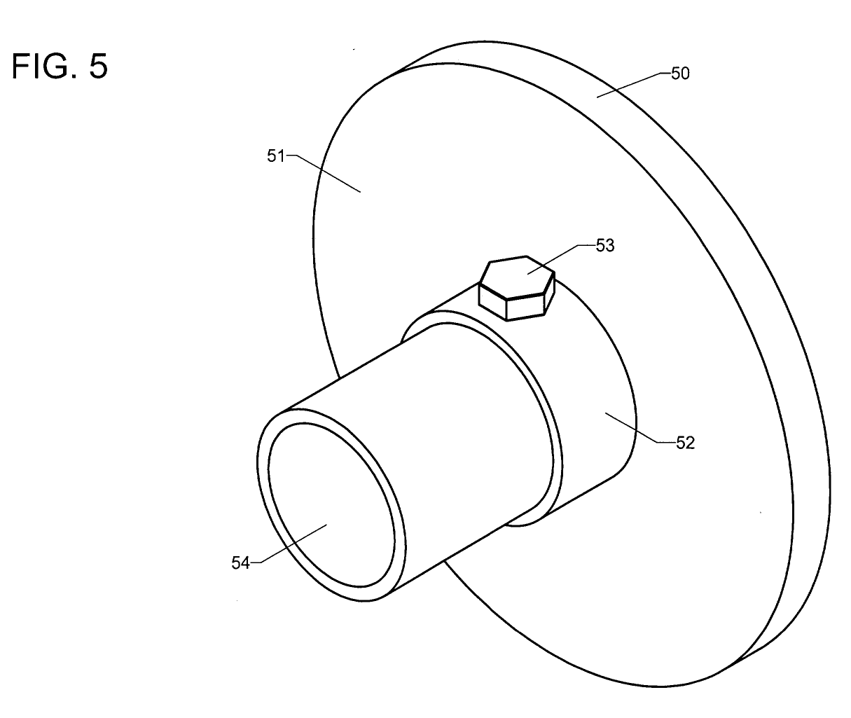

FIG. 5 is perspective view of an end holder coupled to a partial shaft;

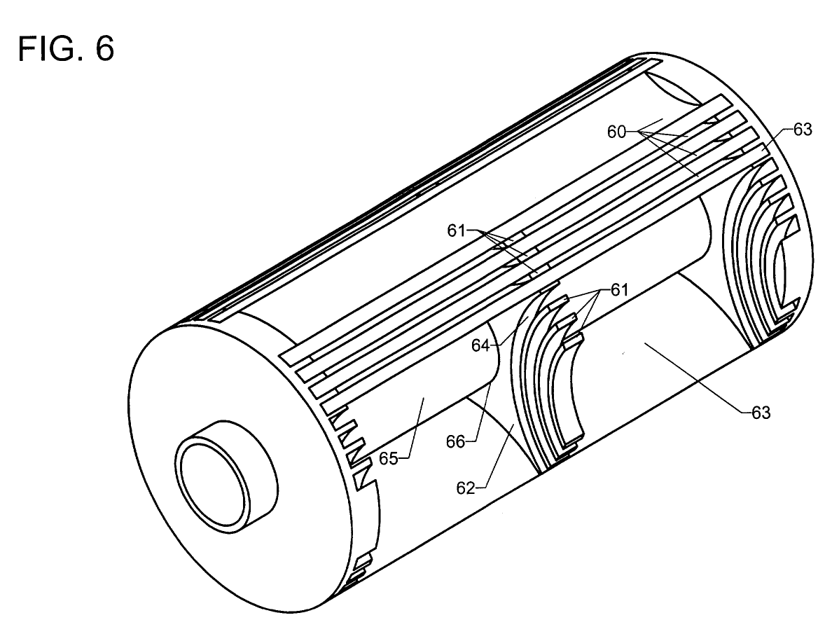

FIG. 6 is a perspective view of a partially assembled four pole rotor with added cross-sectional supports;

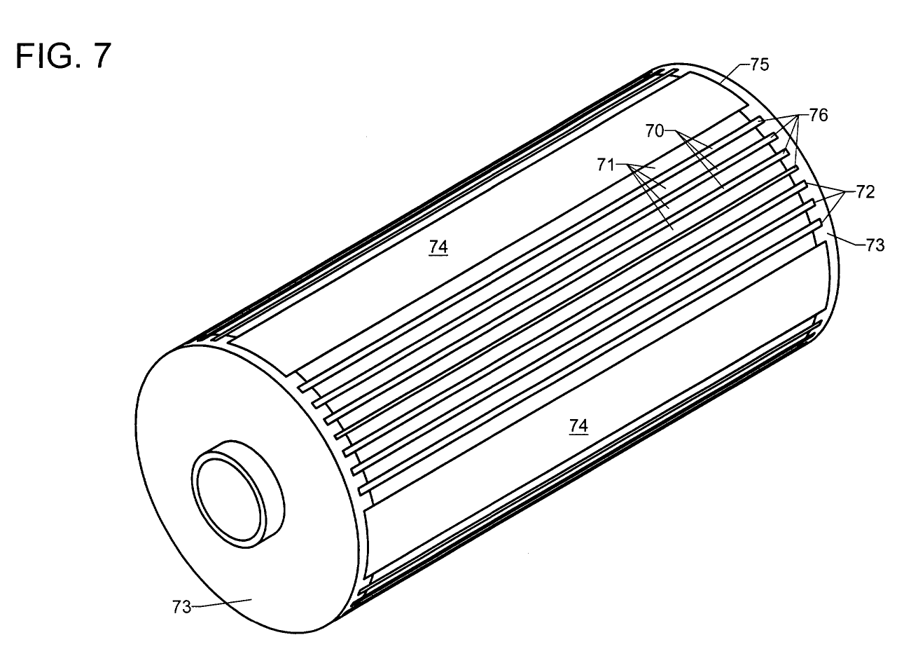

FIG. 7 is a perspective view of a reverse structure four pole rotor;

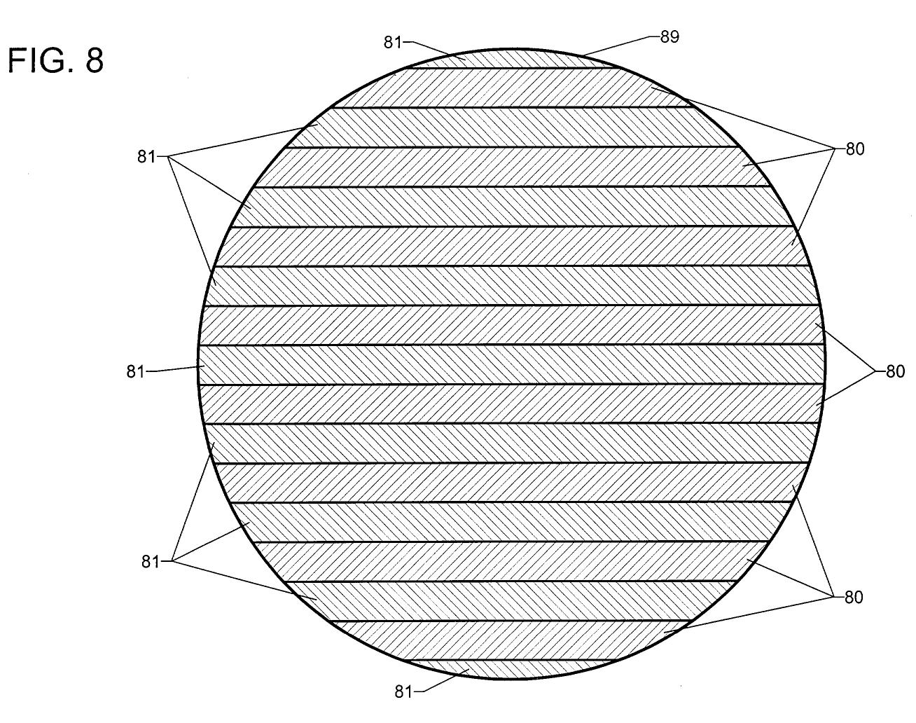

FIG. 8 is a sectional view of a two pole machine composed of alternating layers of nonmagnetic steel and ferromagnetic steel layers with fiber wrapping, the section depicted is perpendicular to the axis of rotation of the rotor;

### REFERENCE NUMERALS

10 magnetic layers

11 magnetic layer outer surfaces

12 end holders

13 recesses

14 inward facing surfaces

15 innermost magnetic layers

16 hole

17 nonmagnetic material

18 extended magnetic layers

19 shaft

21 spaces

22 outer rotor bars

24 outer magnetic layers

30 magnetic layers

31 magnetic layer outer surfaces

32 end holders

33 recesses

34 inward facing surfaces

36 hole

39 shaft

41 spaces

42 outer rotor bars

43 regions

44 outer magnetic layers

50 end holder

51 outward facing surfaces

52 shaft interface

53 features

54 shaft

60 magnetic layers

61 cross sectional supports

62 spider holders

63 innermost magnetic layers

64 outer surfaces

65 shaft

66 hole

70 nonmagnetic layers

71 magnetic layers

72 recesses

73 end holders

74 outer rotor bars

75 additional recesses

76 nonmagnetic layer outer surfaces

80 nonmagnetic steel

81 ferromagnetic steel

89 fiber material

### DESCRIPTION OF THE PREFERRED EMBODIMENT

The following invention can be applied to any dimensions and any number of poles and phases. The term magnetic layer or material refers to something that has a permeability significantly above that of free space. While in most cases this refers to ferromagnetic steel, it is not limited to this exclusively. The term nonmagnetic layer or material refers to something that has permeability near that of free space. Examples of structural nonmagnetic materials are nonmagnetic steels, aluminum, and fiberglass. The term permanent magnet refers to any material that retains a magnetic field after being magnetized. Examples of permanent magnet materials include neodymium-iron-boron, cobalt-samarium, or flexible bonded barium ferrite.

Numerous methods of transmitting torque to and from the rotor can be devised and will be apparent to those skilled in the art. In the following description, torque is transmitted by a shaft passing fully through the center of the rotor. The means of transmitting torque should not be considered as limiting the scope of the invention. Further the shaft mentioned refers to a structural tube that may be solid or hollow and constructed of any material that is structurally appropriate for this function.

Two general types of surface bonding will be mentioned. A low temperature bond refers to bonds that do not require the temperature of the bonding agent to be raised significantly above ambient temperature. Examples of low temperature bonding agents are generally adhesives such as epoxy or are composed of polymers. High temperature bonds refer to bonds that require the temperature of the bonding agent, or one or more of the materials to be bonded, be raised significantly above ambient temperature. Examples of high temperature bonding methods are brazing and welding. Other references to bonding surfaces together can refer to either low temperature bonds or high temperature bonds.

The basic rotor configuration consists of two end holders that hold layers of magnetic material in place. FIG. 1A and FIG. 3A show two examples of such a rotor. The magnetic layers 10, 30 consist of either a single formed sheet of magnetic material or multiple formed sheets of magnetic material that are fully or partially bonded together. The magnetic layers 10, 30 are required to carry much of the load acting on the rotor and therefore must be a suitable material to withstand these loads. The magnetic layers 10, 30 can be comprised of either magnetically anisotropic or isotropic material. The use of magnetically anisotropic material in the rotor may allow an increase in magnetic flux density in the rotor along with a decrease in magnetic core losses. The resulting machine is smaller in volume and weight but still has the same level of power.

In the two pole rotor, FIG. 1A, FIG. 1B, and FIG. 2, the magnetic layers 10 are flat with appropriately shaped magnetic layer outer surfaces 11. The thickness of these magnetic layers 10 may vary from layer to layer or within the layer. The end holders 12 are made out of nonmagnetic material and have recesses 13 on the inward facing surfaces 14 to receive the magnetic layers 10. These recesses 13 function to align and restrain the magnetic layers 10 in the end holders 12. If desired the magnetic layers 10 may be bonded to the end holders 12. The form of these recesses 13 in the end holder 12 is dependent upon the load transferring characteristics required, and can be determined by someone skilled in the art. The end holders 12 may have a larger diameter than the magnetic layer outer surfaces 11, and therefore enclose a portion of the magnetic layer outer surfaces 11, or the end holders 12 can be of the same or smaller diameter as the magnetic layer outer surfaces 11, and be bonded to the magnetic layers 11, as shown in the numerous pole rotor FIG. 3A. If the end holders 12 enclose a portion of the magnetic layer outer surfaces 11 they do not necessarily need to be bonded to them. The innermost magnetic layers 15 extend through a hole 16 in the end holders 12. Additional strips of nonmagnetic material 17 mount between the innermost magnetic layers 15 at the center of the rotor. The nonmagnetic material 17 also extends through the end holders 12, and is bonded to the magnetic layers 10. If extra mechanical strength is required the width of the nonmagnetic material 17 may be extended beyond the end holder hole 16. The extended magnetic layers 18 and nonmagnetic material 17 can be machined to form the shaft 19 of the machine.

For a rotor with greater than two poles, referred to as numerous poles, the magnetic layers 30 are curved with appropriately shaped magnetic layer outer surfaces 31. FIG. 3A, FIG. 3B, and FIG. 4 show examples of four pole rotors. The end holders 32 are comprised of nonmagnetic material and have curved recesses 33 on the inward facing surfaces 34 to receive the magnetic layers 30. These recesses 33 function to align and restrain the magnetic layers 30 in relation to the end holders 32. If desired the magnetic layers 30 may be bonded to the end holders 32. The form of these recesses 33 in the end holders 32 is dependent upon the load transferring characteristics required, and can be determined by someone skilled in the art. The diameter of the end holders 32 may be the same or smaller than the magnetic layer outer surfaces 31 if they are bonded to the magnetic layers 30, or the end holders 32 can be of a larger diameter than the magnetic layer outer surfaces 31 and therefore enclose a portion of the magnetic layer outer surfaces 31, as shown in the two pole rotor FIG. 1A. If the end holders 32 enclose the magnetic layer outer surfaces 31 they do not necessarily need to be bonded to the magnetic layers 30. The characteristics of curvature and the thickness of the magnetic layers 30 can vary from layer to layer. In addition the thickness of the magnetic layers 30 may also vary within each layer. A hole 36 is located in the center of the end holders 32. The hole 36 may either be circular or be an arbitrary shape to improve torque transferring characteristics. A shaft 39 is inserted through this hole 36 and is bonded to the end holders 32.

In both the basic two pole and the basic numerous pole rotors, the rotor has open spaces 25, 45 instead of a solid material for its nonmagnetic layer, as shown in FIG. 1B and FIG. 3B. These spaces 25, 45 can either be left empty or these spaces 21, 41 can be filled with any kind of matter as in FIG. 2 and FIG. 4. Some examples of filling this layer will be given in the description of alternative configurations.

The end holders 12, 32 of either the two pole or the numerous pole rotor may be modified in such a way that the shaft 19, 39 does not extend through the rotor. This is demonstrated for one end holder 50 in FIG. 5. The inward facing surfaces of the pole holder 50 have the recesses required to receive the magnetic layers as previously described. The outward facing surface 51 of the end holder 50 has an integrated shaft or a shaft interface 52. In the shaft type, the shaft would protrude from the outward facing surface 51 of the end holder 50. In the shaft interface type the shaft interface 52 would protrude from the outward facing surface 51 of the end holder 50, and would use mechanical features 53, or bonding, to secure the shaft 54 to the shaft interface 52.

In another rotor configuration, the benefits of a hybrid permanent magnet machine are utilized. Referring to FIG. 2 and FIG. 4, permanent magnets preformed to the appropriate shape or having the required flexibility to conform to the appropriate shape are inserted in the spaces 21, 41 between magnetic layers 10, 30 of the assembled rotor. The permanent magnets are then secured using a low temperature bond. The advantage of this method of assembly is that the permanent magnets can be magnetized prior to securing them to the magnetic layers 10, 30. This prevents the permanent magnets from being exposed to possible high temperature heat treatments incurred during assembly. Possible heat treatments include annealing the magnetic layers 10, 30 and, in some cases bonding, components of the rotor together. In addition the difficult process of magnetizing the permanent magnets while already installed in the rotor is avoided.

For the hybrid permanent magnet machine it may be desired to add saturable bridges between magnetic layers. If the hybrid permanent magnet machine has numerous poles, magnetic contacts can also be added between the innermost magnetic layers of each pole section. Saturable bridges are added by placing multiple bars of magnetic material between the magnetic layers. The saturable bridges span either the length of the rotor or the length between nonmagnetic supports. These bridges can be added in any number and at any location, there are two methods that are the easiest to implement. In the first method a magnetic bridge is positioned in the middle of the pole of each nonmagnetic layer and secured to the magnetic layers. Permanent magnets are added on both sides of the bridge. In the second method the permanent magnets are added to the center of each pole's nonmagnetic layers, and two magnetic bars are secured on both sides of the permanent magnet. Two possibilities are suggested for adding magnetic contact between the innermost magnetic layers of rotor pole sections. First, a spider holder made of magnetic material and spanning the length of the rotor may be added to the rotor. The second possibility is to bond magnetic material pieces in the regions 43 of FIG. 4, between pole segments.

In another rotor configuration, the magnetic layers 60 are mechanically reinforced to withstand greater stresses. This is accomplished by adding multiple cross sectional supports 61 between the magnetic layers 60 as in FIG. 6. The cross sectional supports 61 are bonded to the magnetic layers 60. In the numerous pole machine, multiple spider holders 62 are also located on the interior of the innermost magnetic layers 63. The spider holders 62 have similar outer surfaces 64 to mate with the innermost magnetic layers 63 and are bonded to these layers. If the shaft 65 of the machine passes continuously through the rotor, a hole 66 of appropriate shape will be provided in the spider holders 62. In addition, the spider holders 62 may either be solid or be appropriately shaped to conserve weight. The required quantity and location of the cross sectional supports 61 and spider holders 62 depend on the forces acting on the rotor components and can be determined by someone skilled in the art. Cross sectional supports 61 and spider holders 62 may be integrated in the hybrid permanent magnet machine provided the permanent magnets occupy regions not occupied by these supports.

In another rotor configuration, the magnetic layers 10, 30 are reinforced by securing honeycomb sheets in the spaces 21, 41 between the magnetic layers 10, 30 shown in FIG. 2 and FIG. 4. The cells of the honeycomb sheets extend transversely between the magnetic layers 10, 30. Cross sectional supports 61 and spider holders 62 may be integrated with the honeycomb sheets provided the honeycomb sheets occupy regions not occupied by the cross sectional supports 61.

For a hybrid permanent magnet machine, subjected to large stresses, a new type of structural permanent magnet is utilized. These structural permanent magnets can be incorporated in a large variety of applications that require permanent magnets to be-subjected to large stresses. Suitable applications for these structural permanent magnets include but are not limited to permanent magnet machines and magnetic bearings. The structural permanent magnets are produced by incorporating permanent magnet material into honeycomb sheets. Several methods of incorporating permanent magnets into the honeycomb sheets are detailed but should not limit the scope of this invention. Empty honeycomb cells are inherent in the honeycomb sheets. The size of these cells can be increased by cutting out portions of the honeycomb sheets. Some or all of the empty honeycomb cells are filled with permanent magnets by either forming the permanent magnet in the cells or by preforming them and inserting them into the honeycomb cells. Forming the permanent magnets in the empty honeycomb cells can be accomplished by executing several general procedures. First, the honeycomb sheet should be formed to the shape required for assembly with the rotor. The empty spaces of the honeycomb sheets should then be filled with a composition containing particulate permanent magnet material of such a form that the orientation of the particles is free to change. A magnetic field with the desired orientation must be applied to align the magnet particles until the permanent magnets are fully formed in the honeycomb cells. Examples of forming include but are not limited to sintering and curing of the permanent magnet composition. Similarly, the permanent magnet pieces can also be formed outside the honeycomb and transferred to the empty honeycomb cells. In both methods after the permanent magnets are fully integrated in the honeycomb cells they are magnetized. The resulting magnetic honeycomb sheet can then be assembled with the rotor using a low temperature bond as in the previously mentioned permanent magnet configuration.

In any of the previously mentioned configurations, additional outer rotor bars 22, 42 may be added to the rotor as in FIG. 2 and FIG. 4. The outer rotor bars 22, 42 should span the length between the end holders and the region described, external to the outer magnetic layers 24, 44, and interior to the arc defining the diameter of the magnetic layer outer surfaces 11, 31. The outer rotor bars 22, 42 can either be structural or nonstructural. In the structural case the outer rotor bars 22, 42 should be bonded to both the end holders 12, 32 and the outer magnetic layers 24, 44 and should also be constructed of an adequately stiff material such that the outer rotor bars 22, 42 will transfer loads from the outer magnetic layers 24, 44 to the end holders 12, 32. In addition, recesses or features can be appended to both the outer rotor bars 22, 42 and the end holders 12, 32 to further improve the load transfer characteristics. In both the structural and nonstructural cases the addition of the outer rotor bars 22, 42 reduce audible noise and windage loss. The outer rotor bars 22, 42 may also be made of permanent magnets.

The rotor can be wrapped with a thin layer of material after it has been completely assembled in any of the aforementioned rotor configurations. Wrapping the rotor will result in reduced audible noise and windage losses relative to an unwrapped rotor. This wrapping material is not required to be structural. It would also be preferred for the wrapping material to not be magnetic or conductive.

In another rotor configuration the rotor structure is reversed. In this configuration the nonmagnetic layers 70 act as the structural layers, as in the example four pole rotor of FIG. 7. The magnetic layers 71 are inserted between the nonmagnetic layers 70 and bonded to them. The nonmagnetic layers 70 are inserted into recesses 72 of the end holders 73. If desired the nonmagnetic layers 70 may be bonded to the end holders 73. Outer rotor bars 74 also can be included and additional recesses 75 provided for it in the end holders 73. The diameter of the end holders 73 may be the same or smaller than the nonmagnetic layer outer surfaces 76 if they are bonded to the nonmagnetic layers 70, or the end holders 73 can be of a larger diameter than the nonmagnetic layer outer surfaces 76 and therefore enclose a portion of the nonmagnetic layer outer surfaces 76. If the end holders 73 enclose a portion of the nonmagnetic layer outer surfaces 76 they do not necessarily need to be bonded to the nonmagnetic layers 70. Except for the recesses 72 being aligned with the nonmagnetic layers 70, as opposed to the magnetic layers 71, the end holders 73 are otherwise unaltered as previously described. In addition spider holders 62 may be added to this configuration as in the other configurations. With this configuration the magnetic layers 71 must be included, but they do not need to be structural.

If extremely large stresses are encountered, an additional step may be taken of circumferentially wrapping the assembled rotor with a reinforcing fiber material. This fiber material consists of continuous strands of fiber optionally bonded to the rotor with a low temperature bonding agent. The fiber material must be of adequate stiffness and strength for the rotor to benefit from the wrapping. Compositions of such a material may be of high modulus carbon fiber impregnated with an epoxy bonding agent. This material composition represents an example of a suitable material and should not limit the scope of this invention. Any of the previously mentioned rotor configurations in this invention can be wrapped with fiber material and will benefit from reduced stresses incurred within the rotor. In addition, prior art machines can benefit from being wrapped in this way. One such example is a two pole machine, shown in FIG. 8, composed of alternating layers of nonmagnetic steel 80 and ferromagnetic steel 81 brazed together and machined to be axisymmetric. If this machine were wrapped in a reinforcing fiber material 89 as described, it would be able to withstand even greater stresses.

In addition to the above description other common components can be added to the shaft, such as bearings, encoders, means of coupling to loads, or any such additions. These additions should not be construed as limiting the scope of the invention.

Many manufacturing methods can be devised to produce the described invention by those skilled in the art. The manufacturing usually consists of the individual components of the rotor first being fabricated. This includes the magnetic layers, end holders, and any desired spider holders and nonmagnetic layers. This step is followed by these components being assembled, often in multiple steps. Lastly finishing steps may be taken such as machining the outer surface, wrapping the rotor, or balancing the rotor.

The magnetic layers can be fabricated by numerous methods. The magnetic layers usually consist of single pieces or stacked laminations. Single piece layers can be manufactured by numerous methods including but not limited to casting, forging, bending, rolling, and extruding. Stacked laminations can be manufactured by numerous methods not limited to cutting laminations, applying a bonding agent to surfaces to be bonded, bending the laminations, and stacking the laminations. Cutting the laminations can be accomplished by a number of methods not limited to stamping and shearing. The laminations can be curved, if required, by a number of methods including but not limited to rolling and pressing.

End holders and spider holders can be fabricated with several manufacturing processes including but not limited to casting, milling, and stacking laminations. Cross-sectional supports can be fabricated by numerous methods including but not limited to casting, forging, rolling, or pressing. Permanent magnets and honeycomb sheets, including combinations of both honeycomb and permanent magnets, can be fabricated as previously described.

Assembly of the rotor components can be accomplished by numerous methods. Two general assembly types can be characterized by the step at which the magnetic layers or any nonmagnetic layers are assembled into the recesses of the end holders. In either case, any bonding agents and heat treatment processes can be applied at several stages of the assembly. Heat treatment of any part of the assembly can be conducted to anneal the magnetic layers, bond components of the rotor together, or simultaneously bond and anneal.

In the first method the magnetic layers, end holders, and any spider holders are assembled, after any applicable bonding agents have been applied. This partially assembled rotor can then be heat treated. After the assembly has been cooled any type of nonmagnetic layer material can be inserted into the gap between the magnetic layers. The nonmagnetic layers can consist of any combination of honeycomb sheets, cross-sectional supports, or permanent magnets, as mentioned previously. Any bonding agents required should be applied prior to insertion of the nonmagnetic layer.

For the second rotor assembly method, the magnetic and nonmagnetic layers of each pole are independently stacked to form pole subassemblies. Any applicable bonding agents should be applied prior to stacking. The pole subassemblies can then be assembled to the end holders and spider holders. Any heat treatment processes can be applied after the pole subassemblies are fabricated or after the end holders have been added to the assembly. This assembly process is practical if the nonmagnetic layers are solid or a temporary jig is used to restrain the subassemblies.

After any of the preceding manufacturing methods, if required or desirable, the rotor can be machined to improve the finish of the outer surface. This may often be necessary to improve the tolerance between the rotor and the stator. In addition, the rotor can be wrapped with either a reinforcing material or a non-reinforcing material. Finally while rotating, the rotor can be balanced to produce insignificant reciprocating transverse loads.

From the above description it can be seen by those skilled in the art that a rotor for reluctance machines has been invented that is lightweight and less expensive in both material and assembly. In addition it has been shown that steps can be taken to further increase the mechanical strength of the rotor while only minimally increasing the costs and weight.

While the above description contains many specificities, these should not be construed as limitations on the scope of the invention, but rather as exemplifications of preferred embodiments. Also there are numerous possibilities for other variations.

Accordingly, the scope of the invention should be determined not by the embodiments illustrated, but by the appended claims and their legal equivalents.

What is claimed is:

1. A rotor assembly for a reluctance machine, said rotor assembly comprising:
(a) one or more rotor sections, each of said rotor sections comprising a plurality of shaped and sized magnetic layers with spaces between said magnetic layers, said spaces forming optionally fillable nonmagnetic layers,
(b) a pair of end holders having one or more recess sections corresponding to each said rotor section, each of said recess sections comprising a plurality of recesses, said recesses being configured, dimensioned, and positioned to secure said magnetic layers.

2. The rotor assembly as defined in claim 1, wherein a percentage of the volume of said nonmagnetic layers is empty.

3. The rotor assembly as defined in claim 1, wherein a percentage of the volume of said nonmagnetic layers is filled with nonmagnetic matter.

4. The rotor assembly as defined in claim 3, wherein a percentage of the volume of said nonmagnetic matter consists of a quantity of distributed, shaped, and sized cross sectional supports, said cross sectional supports secured to said magnetic layers.

5. The rotor assembly as defined in claim 3, wherein a percentage of the volume of said nonmagnetic matter consists of a material selected from a group consisting of honeycomb and honeycomb with embedded permanent magnets, said material secured to said magnetic layers.

6. The rotor assembly as defined in claim 3, wherein a percentage of the volume of said nonmagnetic matter consists of permanent magnets, said permanent magnets secured to said magnetic layers.

7. The rotor assembly as defined in claim 1, further including one or more distributed, sized, and shaped spider holders, said spider holders being configured, dimensioned, and positioned to secure to a portion of the innermost magnetic layer of said rotor sections, said spider holders secured to innermost magnetic layers of said rotor sections.

8. The rotor assembly as defined in claim 7, further including one or more continuous strands of fiber circumferentially wrapped around said rotor assembly and secured to said rotor assembly, said fibers acting to reinforce said rotor.

9. The rotor assembly as defined in claim 1, further including one or more continuous strands of fiber circumferentially wrapped around said rotor assembly and secured to said rotor assembly, said fibers acting to reinforce said rotor.

10. A rotor assembly for a reluctance machine, said rotor assembly comprising:
(a) a plurality of shaped and sized magnetic layers with spaces between said magnetic layers, said magnetic layers grouped to form one or more rotor sections,
(b) optionally fillable nonmagnetic layers between said magnetic layers,
(c) a pair of end holders having a quantity of recess sections corresponding to each said rotor section, each of said recess sections comprising a plurality of recesses, said recesses being configured, dimensioned, and positioned to secure said magnetic layers,
(d) a torque transmitter for transferring rotor torque, said torque transmitter selected from group consisting of said torque transmitter connected to said end holders, said torque transmitter part of said end holders, and said torque transmitter part of said magnetic and nonmagnetic layers.

11. The rotor assembly as defined in claim 10, wherein a percentage of the volume of said nonmagnetic layers is empty.

12. The rotor assembly as defined in claim 10, wherein a percentage of the volume of said nonmagnetic layers is filled with nonmagnetic matter.

13. The rotor assembly as defined in claim 12, wherein a percentage of the volume of said nonmagnetic matter consists of a quantity of distributed, shaped, and sized cross sectional supports, said cross sectional supports secured to said magnetic layers.

14. The rotor assembly as defined in claim 12, wherein a percentage of the volume of said nonmagnetic matter consists of a material selected from a group consisting of honeycomb and honeycomb with embedded permanent magnets, said material secured to said magnetic layers.

15. The rotor assembly as defined in claim 12, wherein a percentage of the volume of said nonmagnetic matter consists of permanent magnets, said permanent magnets secured to said magnetic layers.

16. The rotor assembly as defined in claim 10, further including one or more distributed, sized, and shaped spider holders, said spider holders being configured, dimensioned, and positioned to secure to a portion of the innermost magnetic layer of said rotor sections, said spider holders secured to innermost magnetic layers of said rotor sections.

17. The rotor assembly as defined in claim 16, further including one or more continuous strands of fiber circumferentially wrapped around said rotor assembly and secured to said rotor assembly, said fibers acting to reinforce said rotor.

18. The rotor assembly as defined in claim 10, further including one or more continuous strands of fiber circumferentially wrapped around said rotor assembly and secured to said rotor assembly, said fibers acting to reinforce said rotor.

19. A rotor assembly for a reluctance machine, said rotor assembly comprising:
(a) one or more rotor sections, each of said rotor sections comprising a plurality of shaped and sized nonmagnetic layers with space between said nonmagnetic layers for a plurality of shaped and sized magnetic layers,
(b) a pair of end holders having one or more recess sections corresponding to each said rotor section, each of said recess sections comprising a plurality of recesses, said recesses being configured, dimensioned, and positioned to secure said nonmagnetic layers,
(c) a torque transmitter for transferring rotor torque, said torque transmitter selected from group consisting of said torque transmitter connected to said end holders, said torque transmitter part of said end holders, and said torque transmitter part of said magnetic and nonmagnetic layers.

20. The rotor assembly as defined in claim 19, further including one or more distributed, sized, and shaped spider holders, said spider holders being configured, dimensioned, and positioned to secure to a portion of the innermost nonmagnetic layer of said rotor sections, said spider holders secured to innermost nonmagnetic layers of said rotor sections.

21. The rotor assembly as defined in claim 20, further including one or more continuous strands of fiber circumferentially wrapped around said rotor assembly and secured to said rotor assembly, said fibers acting to reinforce said rotor.

22. The rotor assembly as defined in claim 19, further including one or more continuous strands of fiber circumferentially wrapped around said rotor assembly and secured to said rotor assembly, said fibers acting to reinforce said rotor.

23. A method for reinforcing a rotor assembly for a reluctance machine, said method consisting of wrapping one or more continuous strands of fiber circumferentially around said rotor assembly and secured to said rotor assembly.

24. A rotor assembly for a reluctance machine, said rotor assembly comprising:
(a) a plurality of shaped magnetic layers and shaped nonmagnetic layers, said magnetic layers and nonmagnetic layers bonded together,
(b) a torque transmitter composed of part of said magnetic and said nonmagnetic layers,
(c) one or more continuous strands of fiber are circumferentially wrapped around said rotor assembly and secured to said rotor assembly, said fibers acting to reinforce said rotor.

25. A method of manufacturing a rotor assembly for a reluctance machine; said method comprising:
(a) fabricating magnetic layers and any desired nonmagnetic layers,
(b) fabricating end holders including recesses and any desired spider holders,
(c) securing said magnetic layers to said end holders and any said desired spider holders,
(d) securing said magnetic layers to any said desired nonmagnetic layers.

26. The manufacturing method as defined in claim 25, wherein said fabricating said magnetic layers consists of shearing and pressing said magnetic layers.

27. The manufacturing method as defined in claim 25, wherein said fabricating said end holders and any said desired spider holders consists of casting said end holders and any said desired spider holders.
